(19) United States
(12) Patent Application Publication
(10) Pub. No.: US 2025/0252168 A1
(43) Pub. Date: Aug. 7, 2025

(54) BIOMETRIC VERIFICATION USING CHARACTERISTIC ELECTROPHYSIOLOGICAL FEATURES

(71) Applicant: IDENTITA, INC., CONCORD (CA)

(72) Inventors: ROCCO STEFANO, CONCORD (CA); Hirad KARIMI, CONCORD (CA)

(73) Assignee: IDENTITA, INC., CONCORD (CA)

(21) Appl. No.: 19/040,012

(22) Filed: Jan. 29, 2025

Related U.S. Application Data
(63) Continuation-in-part of application No. 18/786,455, filed on Jul. 27, 2024, now abandoned.
Application No. 18/786,455 is a continuation of application No. 17/480,296, filed on Sep. 21, 2021, now Pat. No. 12,050,672.

(51) Int. Cl. G06F 21/32; G06F 18/28; G06N 20/10

(52) U.S. Cl. CPC G06F 21/32; G06F 18/28; G06N 20/10

(57) ABSTRACT

A method and device(s) for using ECG signals for biometric identification and/or authorization that includes a machine-learning based signal processing approach for significantly removing noise signals from ECG signals being used. The present invention further includes a probability-based additional approach for further enhancing the signal relative to signal segments falsely identified as an actual ECG signal. In extended applications, the same refined ECG signals can be additionally used for parallel functions, such as health and wellness monitoring.

### RELATED APPLICATIONS

This application is related to U.S. application Ser. No. 17/480,296 filed on Sep. 21, 2021 and U.S. application Ser. No. 18/786,455 filed on Jul. 27, 2024, the entire content of both applications being incorporated herein by reference to the fullest extent permissible.

### FIELD OF THE INVENTION

The present invention generally relates to a method for obtaining reliable (e.g., with reduced extraneous noise and false signals) electrophysiological signals, which signals can be used in a variety of applications, such as biometrics. In a particular example, the present invention more particularly relates to methods and devices for identification and identity authentication using biometric information. More particularly, the present invention relates to highly portable or even wearable devices for identification and identity authentication.

### BACKGROUND OF THE INVENTION

Biometrics relates to measuring and analyzing unique (from individual to individual) features of the human body such as fingerprints, retina vein patterns, irises, voice patterns, facial structure, and hand/finger measurements for either identify authentication (i.e., one-to-one verification—“Am I who I claim I am?”), or identification (i.e., one-from-many identification—“Who am I?”) purposes.

A particular use of biometric authentication is to provide a more secure identity authentication, compared with, for example, access badges (which can be lost or stolen) or pass codes (which can be forgotten, or used by someone other than an authorized individual).

Generally, biometric systems include capture devices to acquire biometric information, software algorithms for effective authentication/identification, and databases that store reference biometric data for comparison.

In a known generic biometric authentication process, biometric data is generated first by a step of enrollment in which a biometric characteristic is captured by an appropriate sensor. The captured information is then mathematically transformed into a numerical model called a reference template. The mathematical transformation may be conventional in the art, as specified in, for example, American National Standard for Information Technology—“Finger Minutiae Format for Data Interchange”: ANSI INCITS 378-2004 and its revisions (in the case of using fingerprint information).

Thereafter, one or more reference templates are stored in a conventional computer database as data files. The reference templates are sometimes known in the art as “gallery” templates. For the sake of simplicity in the present application, they will be referred to herein simply as reference templates.

For authentication (i.e., proof of identity), an individual presents his biometric characteristic by way of an appropriate detector or reader (e.g., if the information is fixed in a recording of some type). The detected biometric characteristic is then mathematically transformed into an input template (sometimes known in the art as a “probe” template) using the same transformation for creating the reference template, thereby creating an input template that can be compared with a respective stored reference template (for that individual) to confirm or reject the identity of the individual. The process of identification is similar to authentication, but the input template instead is compared against a plurality of stored reference templates to try to find a match.

It is known in the art that the reliability of matching between an input template and reference template can vary, depending on a number of factors. For example, fingerprints are comparatively invariable, even as a person ages. Thus, barring external alteration or disfigurement, both input and reference templates can be recorded with relative precision, and subsequent matching can usually be performed with a relatively high degree of reliability. However, fingerprints are susceptible to being copied (from fingerprints left on other objects, for example), and can be thus misused.

On the other hand, certain biometric parameters are inherently dynamic, such as retinal vein patterns, facial feature recognition, or voice pattern recognition. While they present certain lasting features which can form the basis for biometric authentication comparison, they can be variable (to varying degrees) at any given moment. For example, retinal veins have blood flowing through them which can change the shapes of the blood vessels, especially with variations in blood pressure and the like. Facial feature topography can vary as someone ages, causing distances between given reference points to vary. Voice patterns may be variable at any given moment (e.g., during a cold or while suffering from a sore throat). Thus, the comparison between the input and reference templates is subject to variations that makes matching with precision more difficult.

Among electrophysiological signals, it is generally known to use electrocardiograms (“ECGs”) for biometric identification purposes. See, for example, U.S. Pat. No. 9,699,182 of E1 Saddik et al. (for “Electrocardiogram (ECG) Biometric Authentication,” issued on Jul. 4, 2017).

As is known, the human heart contracts and relaxes (i.e., “beats”) in correspondence with a regular electric impulse generated in the heart muscle (generally, from the sinoatrial node to the atrioventricular node to the His-Purkinje network). The electrical signal is externally detectable via ECG at the skin in a known manner, typically (but not exclusively) using one or more electrodes positioned on the human torso (and sometimes also on the extremities) in a known manner. This signal can generate a characteristic potential versus time trace representing a given heartbeat (as generically illustrated in FIG. 1, by way of illustration).

However, this varying electrical signal can also be detected elsewhere on the exterior of the body (i.e., on the skin surface), including, for example, the fingertips. This can greatly facilitate ECG detection, in comparison to a more invasive and/or complicated use of electrodes on the torso (requiring some degree of disrobing, increased inconvenience of placing and removing a plurality of electrodes, etc.). Another increasingly popular option is detection via wearable personal devices (e.g., via “smartwatches” or “smart rings” or “pendant necklaces” and the like), generally held proximal to the human body.

FIG. 1 generally illustrates one full heartbeat waveform signal (and part of a subsequent second) as represented by an ECG trace (generally, electrical potential along the Y-axis relative to time along the X-axis). A given heartbeat (as recorded by ECG) includes P, QRS, and T complexes, as shown in FIG. 1. As is well-known in physiology, the P wave represents the start of electrical depolarization of the sinus node and the sequential right and left atrial contraction, the QRS complex signifies the electrical depolarization of the right and left ventricles, and the T wave corresponds to the electrical repolarization of the ventricles.

The Q, R, and S waves occur in rapid succession, and are considered to reflect a single collective event. They are thus usually considered together as the “QRS complex” or the “QRS interval.” A Q wave is any downward deflection after the P wave. An R wave follows as an upward deflection, the S wave is any downward deflection after the R wave, and the T wave follows the S wave. These relationships (over time) can be seen in FIG. 1.

The signal features illustrated in FIG. 1 are generally common in all human heartbeats. Obviously, cardiac behavior (and the resultant ECG traces) can change under the influence of stress, disease, physical exercise, medications, etc. As a result, an electrocardiogram for even the same person may vary at different times (i.e., have variations in potential changes and/or time durations). FIG. 2 schematically illustrates ECG signals taken from a plurality of different individuals, showing comparative variations therebetween. An average (i.e., an average electrical potential at a given time) of the samples is also illustrated by the bold black dashed line 20.

The electrical signal detectors (electrodes) used for ECG detection may also register electrical noise anomalies (i.e., false or errant signals) that can interfere with obtaining a clear and reliable signal for use. In particular, the detecting electrodes are prone to detecting electrical noise from musculature other than the heart, or from movement of the fingers/fingertips contacting the detecting electrodes. This can add additional extraneous signal spikes to the detected signal.

FIG. 3 schematically illustrates a relationship between a plurality of actual QRS interval samples (generally indicated as a group at 30, and generally conforming to the QRS waveform segment illustrated in FIG. 1) and several detected false anomalies (some representative ones indicated at 32).

Thus, while ECG information contains unique information that can be used for biometric authorization/identification, a given sample of ECG information is subject to variations and/or signal noise, and accurate detection of ECG information can be subject to or otherwise obscured by extrinsic noise or other false inputs.

### SUMMARY OF THE INVENTION

The present invention is therefore most generally directed to systems and methods for extracting reliable or accurate ECG information from raw detected ECG signals. In particular, the present invention uses a method of dynamic machine learning to improve reliable and robust extraction of ECG information from detected signals (i.e., generally, classifying elements of a detected signal as “true” ECG signal elements versus noise). In one embodiment of the present invention, a support vector machine is trained for use as a classifier. In another embodiment of the present invention, a neural network is used for classification.

In a preferred example of the present invention, a portable and easy to produce input device can be used to detect individual ECG information. In a particular example, wearable or easily carried devices, such as, without limitation, rings or keychains or pendants or wrist-mounted (or more generally, arm-mounted or leg-mounted) devices and the like are adapted for use according to the present invention. In a preferred example of the present invention, a highly portable and easy to produce input device can be used to detect individual ECG information. In a particular example, wearable or easily carried devices, such as, without limitation, rings or keychains or pendants and the like are adapted for use according to the present invention. In a particular application according to the present invention, the high-quality ECG signal obtained according to the present invention can be used in a method of identifying or authorizing a given individual user.

### BRIEF DESCRIPTION OF THE DRAWINGS

The present invention will be even more clearly understood with reference to the drawings appended hereto, in which:

FIG. 1 illustrates a generic example of an ECG plot representing a first heartbeat and part of a second, including characteristic features thereof;

FIG. 2 schematically illustrates variations in ECG information recorded from a plurality of subjects, and an average (electrical potential over time) of the plurality of samples;

FIG. 3 schematically illustrates errant or false signals relative to a plurality of desirably detected QRS complex;

FIG. 4 is a schematic view of an interface apparatus usable according to the present invention for detecting an ECG signal from a user;

FIG. 4A is a schematic block diagram of the operational elements of the interface apparatus in FIG. 4;

FIG. 4B is a flow diagram illustrating a filtering sequence to remove baseline drifts from a raw detected ECG input signal in the present invention;

FIG. 5 is a high-level process diagram illustrating an example of machine learning for improving ECG element extraction;

FIG. 6 illustrates a process of incrementally analyzing a raw input signal using the machine learning process of the present invention, particularly for identifying QRS interval features;

FIG. 7 illustrates an implementation of the present invention in a motor vehicle, in which electrodes or other suitable detectors of ECG information could be located in one or more of the steering wheel, a console gearshift, or even the seatback of the driver's seat;

FIG. 8 illustrates a basic example of implementation of the present invention (e.g., for identity authentication for secured access entryways);

FIG. 9 illustrates a process according to an embodiment of the present invention for training a neural network;

FIG. 10 illustrates a process according to an embodiment of the present invention for ECG feature detection using the trained neural network of FIG. 9;

FIG. 11A generally illustrates a wearable ring device implementation according to the present invention, on a finger of a user by way of example;

FIG. 11B illustrates the wearable ring device of FIG. 11A, in which the user is actuating additional or supplemental functionality according to the present invention;

FIG. 12 is a perspective view of a wearable ring device according to the present invention;

FIG. 13A is a plan view of a wearable ring device according to the present invention illustrating an additional example of how the ring device is constructed;

FIG. 13B is an exploded perspective view of the ring device of FIG. 13A, generally illustrating the interrelationship of constituent parts of the ring device;

FIG. 13C is a perspective view corresponding to FIG. 13B but illustrating the assembled ring device;

FIG. 14 is a schematic block diagram of the operational elements of the wearable ring device according to the present invention.

### DETAILED DESCRIPTION OF THE PRESENT INVENTION

As an initial matter, details of various aspects of the present invention as set out herein below, as well as details of various implementations thereof are meant to be combinable and interchangeable to the fullest extent evident to one of ordinary skill in the art, even in the absence of express linking language to that effect.

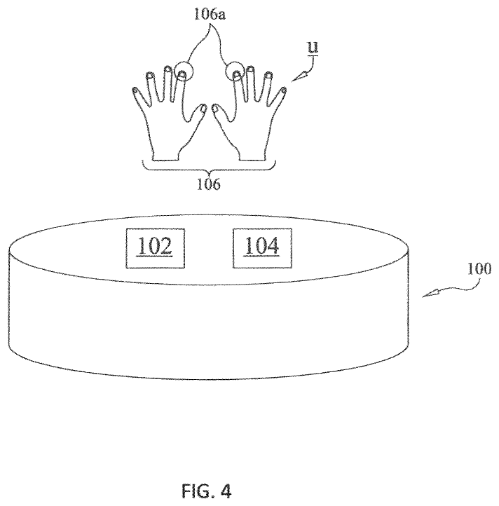

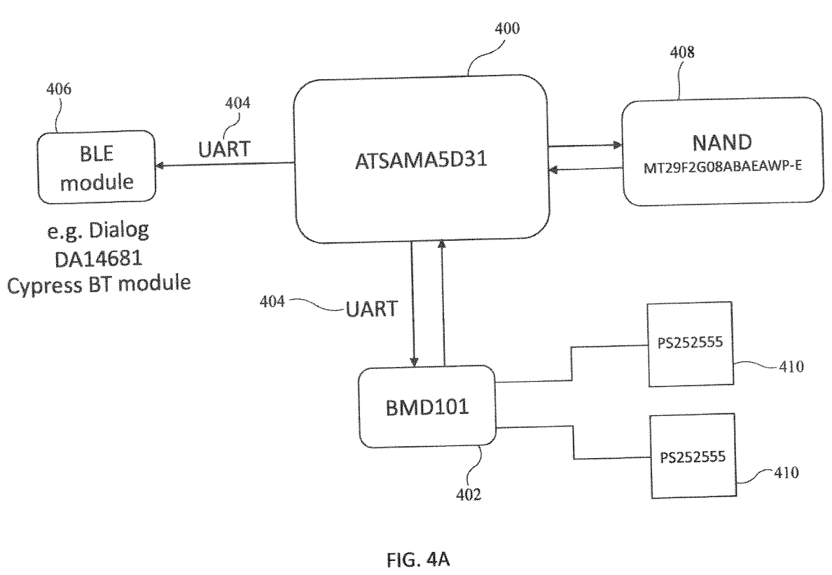

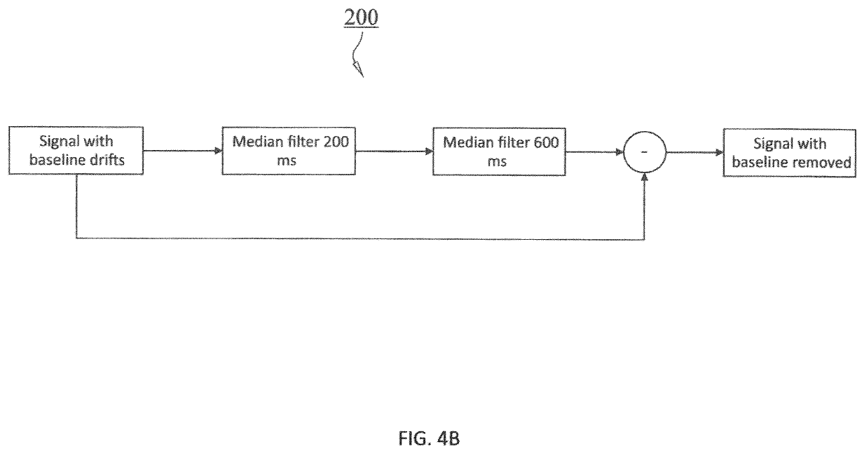

FIG. 4 schematically illustrates an example of a simple stand-alone user interface device 100 usable according to the present invention. In general, ECG information is collected from a user U by touching electrically conductive contacts or sensors (e.g., electrodes) 102, 104 respectively with a fingertip 106a from each hand 106. (“Sensor” and “contact” will be used interchangeably herein.) The sensors 102, 104 may be preferably relatively small (for example, 1 cm² by 1 cm²) in order to contribute to miniaturization of the overall device 100. They may be conventional metallic contact surfaces (made of a sufficiently conductive metal material). Patches of electrically conductive ink or graphene could be also used (which lends itself to simplicity of manufacture, by using known ink and 3D printing methods). A commercially available example of a detection device of this general exterior form (though not necessarily substantively corresponding to device 100) is the “KardiaMobile” two-pad detection device from AliveCor. Alternatively, a single contact or sensor as described can be provided and still be usable according to the present invention. However, two or more sensors (or, more generally, inputs) in this sense are generally preferable in terms of resultant improvement in ECG signal detection.

In general, the interface device 100 is preferably compact (i.e., relatively small), and includes an internal electronic architecture that is simple and reliable, preferably with relatively low power consumption. For example, a 3-5 year operational life on battery power (though this is usage dependent) is a desirable target. For convenience, battery storage (e.g., 800 mAh) may be rechargeable using simple conventional means, such as a USB (particularly, a micro USB) connection to power. In general, the interface device 100 can be used both for initial enrollment as well as for each identification/authentication instance in subsequent operation. Obviously, however, more than one appropriately networked (or otherwise operably connected) interface devices 100 can be used as may be desired. Also, the round “puck” like embodiment in FIG. 4 is merely one example of an interface form.

FIG. 4A is a block diagram illustrating an example functional arrangement of elements in the interface device 100. As seen in FIG. 4A, required processing may be provided by an ARM (Advanced RISC Machine) microprocessor 400 (e.g., the low-power ATSAMA5D31 microprocessor from Microchip), supporting a variety of Secure Hash Algorithm protocols such as SHA-256 and AES-256/512 hashing and encryption functionality (in particular to protect and secure enrolled reference templates as well as detected biometric information).

The interface apparatus further includes an ASIC bio-sensor 402 for processing the detected ECG signals, such as the commercially available NeuroSky BMD101 CardioChip biosensor providing digital signal processing functionality. The bio-sensor 402 communicates with the microprocessor 400, for example, via a Universal Asynchronous Receiver/Transmitter (UART) 404, as is conventionally known. A low-energy Bluetooth transceiver module 406 (e.g., a Dialog DA14681 module from Dialog Semiconductor in the United Kingdom, or a Cypress Bluetooth module from Cypress Semiconductor) provides wireless communication capability with other relevant systems (e.g., locking systems). The Bluetooth transceiver module also communicates with the microprocessor 400 via a UART 404. Memory capacity can be provided by a flash memory 408, such as a NAND flash memory (e.g., MT29F2G08ABAEAWP-E from Micron Technology).

The electrode sensors 410 in interface device 100 (corresponding with sensors 102, 104 in FIG. 4) may be commercially available sensors (for example, from Plessey Semiconductors, Ltd. in the United Kingdom, Part No. PS252555).

The interface device 100 may be configured to use a known commonly used operating system, as needed, such as, without limitation, Linux, Windows, Mac OS/X, or Android OS. The interface device 100 may be connected to related systems in a known manner either wirelessly (e.g., via Bluetooth protocols) or via a USB connection.

Alternatively, standard wired medical electrodes applied to the torso (and, possibly, additionally the extremities) could be used according to known ECG methods in order to obtain and record ECG information from user U. A single sensor input could be used, but use of at least two sensors is preferable with respect to providing a better quality signal.

In a specific example of the present invention, it is possible at any given moment that a given user unexpectedly cannot be identified or authenticated via the basic ECG-based system of the present invention due to an unanticipated technical problem. It can therefore desirable according to the present invention to use an electrically capacitive material for the sensors 102, 104 so that the sensors 102, 104 can additionally function as fingerprint readers in addition to detecting an ECG signal. The thusly read fingerprint(s) can serve as a backup biometric identification/authentication parameter in case the ECG comparison cannot be carried out, or if the ECG comparison detects a partial discrepancy between an input ECG template and a reference ECG template, such that identification/authentication cannot be fully ruled out but the comparison is placed in doubt. The use of a capacitive touch sensor for fingerprint detection is known in the art, and is used in some smartphone electronic system locks or in fingerprint readers at border control posts and the like.

A working example of biometric authentication/identification in accordance with the present invention will be set forth here by way of example.

In the field of biometrics, an initial enrollment process is used in order to collect the biometric information needed for use as reference templates. An enrollment process according to the present invention includes recording ECG information corresponding to a first plurality of user heartbeats for training the identification/classification system according to the present invention. With reference to device 100 in FIG. 4, for example, a user U touches a finger 106a from each hand 106 to sensors 102, 104, respectively, until a desired number of N heartbeats is recorded. The heartbeats can be also indicated visually while recording, for example, on a wave tracing electronic screen in a known manner.

Registration of the identifying features of the ECG information taken from the first plurality of heartbeats is then refined by recording ECG information from a second plurality of user heartbeats taken from the user in the same enrollment session.

Preferably, the raw input ECG signal is subjected to pre-processing, consisting of one or both of baseline wander removal and signal de-noising (i.e., signal noise reduction), in part to address electrical background noise in the system, and also to eliminate or at least reduce physiological noise detected from muscle movements in the subject using the device (e.g., signals corresponding to stray fingertip movement across the detection sensors. The signal pre-processing could occur onboard in the interface device 100 or off board, after transmitting the signal information, e.g., in a MATLAB computational environment.

First the raw signal is subject to a low pass filter (e.g., with a cutoff of 40 Hz).

Baseline drift (also sometimes referred to in the art as “baseline wander”) in electrocardiogram (ECG) signals is another type of signal noise, and can be caused by factors such as respiration of the subject, variations in electrode impedance, and excessive movement of the subject during signal acquisition. Unless baseline wander is effectively removed, the accuracy of any feature extracted from the ECG, such as timing and duration of the ST-segment, is compromised. Noise from baseline wander is an important issue in ECG because it impedes accurate visual inspection of ECG waveform traces. Reducing the baseline drift to a near zero value also aids in computerized detection and delineation of the wave complexes.

According to the present invention, baseline drift can be eliminated using a sequence 200 of median filtering using the known MATLAB platform, as seen in FIG. 4B. For example, a 200 ms filter may be followed by a 600 ms filter, as illustrated.

Noise in the signal is further reduced by using Discrete Wave Transform (DWT) coefficients using Daubechies 4 wavelets. This approach is discussed in, for example, “Perfect Reconstruction Binomial QMF-Wavelet Transform,” by Akansu et al. (Proc. SPIE Visual Communications and Image Processing, pp. 609-618, vol. 1360, Lausanne, Switzerland, 1990, the contents of which are incorporated herein by reference. This formulation is based on the use of recurrence relations to generate progressively finer discrete samplings of an implicit mother wavelet function; each resolution is twice that of the previous scale.

DWT can be preferable to conventional methods of eliminating electrical noise (compared with, for example, low-pass filters used with Fast Fourier transforms and the like), especially if the underlying signal is not stationary, with variable content over time.

The signal is further smoothed (i.e., increasing the precision of the data without distorting tendencies or trends in the signal) using a known approach such as Savitzky-Golvay filtering, using convolution, fitting successive subsets of adjacent data points with a low-degree polynomial using linear least squares. The approach is described, for example, by Savitzky and Golay in “Smoothing and Differentiation of Data by Simplified Least Squares Procedures”. Analytical Chemistry. 36 (8): 1627-39, 1964, the contents of which are incorporated herein by reference in its entirety.

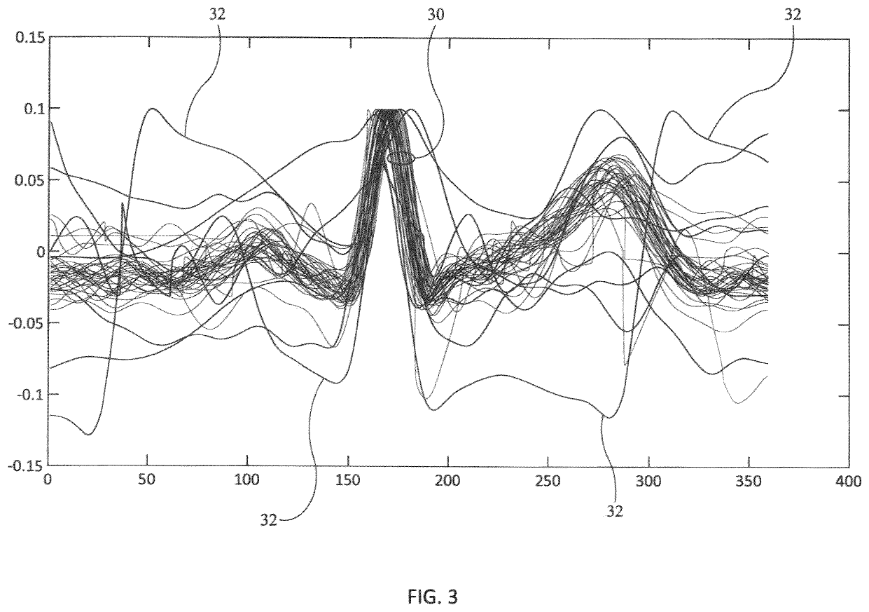

Muscle noise (from the stray finger movement and the like) can be removed by filtering out portions where mathematical analysis indicates the derivative of the signal is relatively high, indicating a corresponding large slope of the signal curve, characteristic of a steep local spike. This kind of behavior can be seen graphically, for example, in many of the noise signals 32 in FIG. 3.

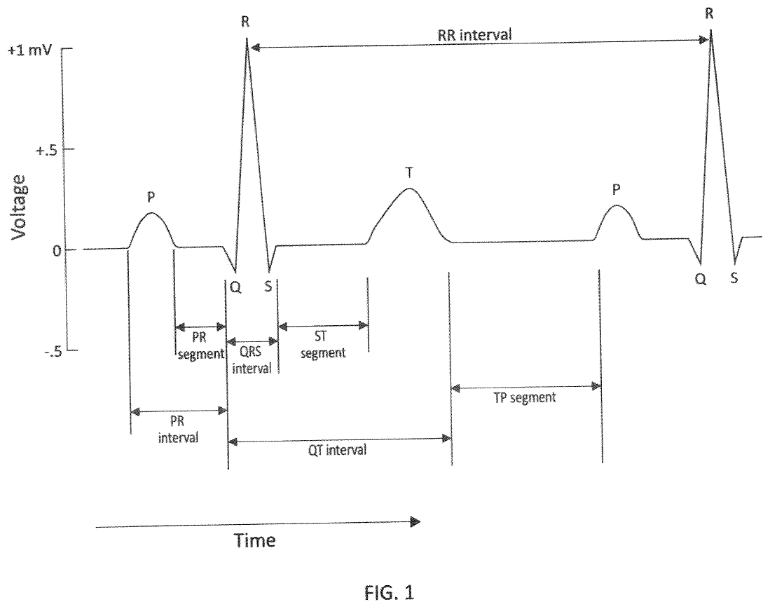

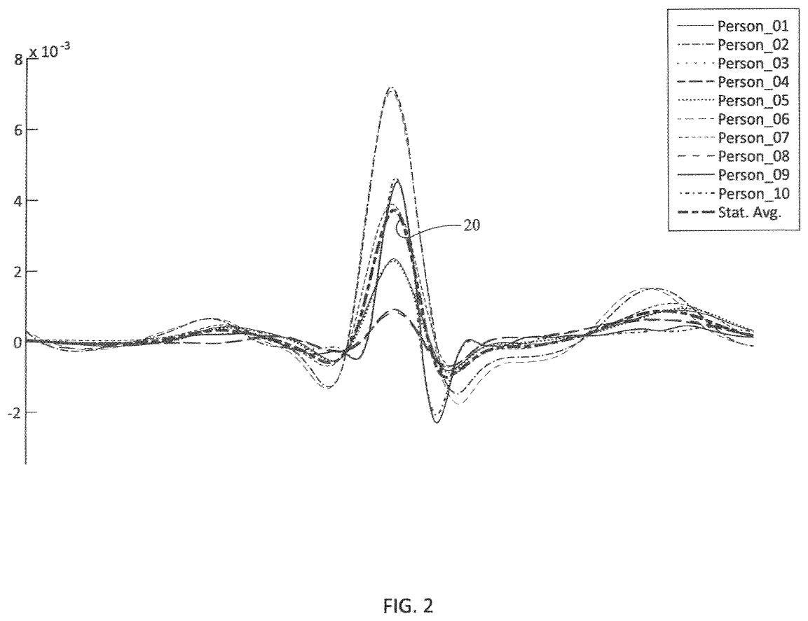

With reference to FIG. 1, the peak Q amplitude and time (with respect to the R peak), the R peak amplitude, the S peak amplitude and time (with respect to the R peak) are extracted from the reduced-noise signal, according to the present invention. An example of feature extraction according to the present invention includes locating R peaks in the pre-processed signal using the known Pan-Tompkins algorithm. See, for example, Pan and Tompkins in “A Real-Time QRS Detection Algorithm.” IEEE Transactions on Biomedical Engineering. BME-32 (3): 230-236, March 1985, the complete contents of which are incorporated herein by reference.

The Pan-Tompkins algorithm is commonly used to detect QRS complexes in electrocardiogramals (ECG). As previously discussed, the QRS complex represents ventricular depolarization and includes the main central R spike visible in an ECG signal (see FIG. 1). This feature makes it particularly suitable for measuring heart rate, the first way to assess the heart health state. As previously mentioned, the QRS complex is composed by a downward deflection (Q wave), a high upward deflection (R wave) and a final downward deflection (S wave).

The Pan-Tompkins algorithm applies a series of filters to highlight the frequency content of this rapid heart depolarization and removes the background noise. Then, it squares the signal to amplify the QRS contribution. Finally, it applies adaptive thresholds to detect the peaks of the filtered signal. Pan and Tompkins reported that 99.3% of QRS complexes were correctly detected using their algorithm.

Q and S peaks were extracted by mathematically locating signal minima in the interval of ±50 ms on either side of the R peak time, respectively. By way of example, an optimal part of the pre-processed signal for use according to the present invention is in a time interval in which the difference between R peak amplitudes does not exceed a predetermined threshold.

To obtain a signal to be worked with according to the present invention, M individual segments (where a “segment” is a full heartbeat cycle) are averaged. M may for be example two ECG segments. Thereafter, N (e.g., five) averaged ECG segments are extracted. In addition to the Q, R, and S peak amplitudes, and Q and S peak times, the first 25 Fourier coefficients of each N averaged ECG segments is also calculated.

The present invention uses a machine learning process to improve accurate extraction of ECG feature information from an input signal (which, as explained above, is subject to noise and other extrinsic signals).

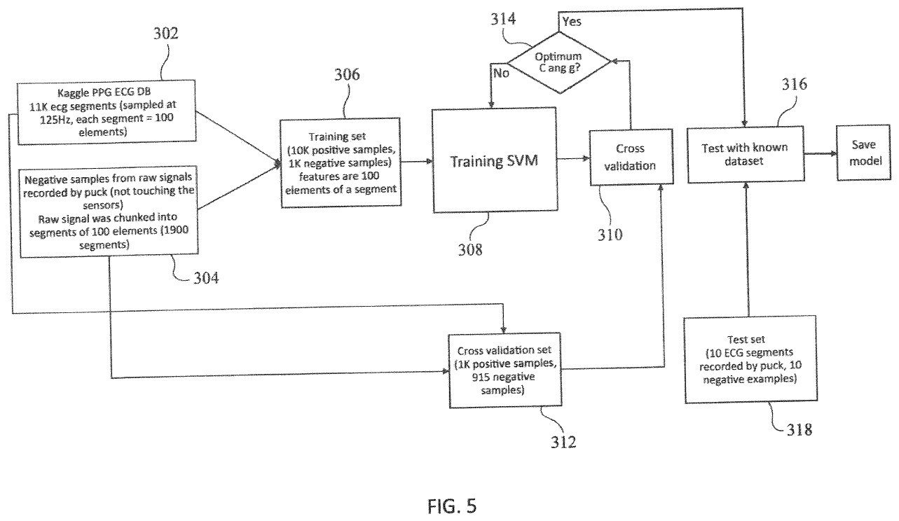

FIG. 5 schematically illustrates, at a high level, a machine learning process 300 for initially training the system. This learning process can be referred to as “deep learning,” in which, instead of breaking down training sets of data to particular features, a large dataset universe is used with raw input (e.g., a 1-D signal or a 2-D image) to train a support vector machine (SVM) without having to extract features from the training data input.

In a particular example of the invention, a support-vector machine (“SVM”) is used to develop a classification model by which true ECG features are distinguished from anomalies, using a body of training data to infer an appropriate basis for distinctions. See, for example, Fletcher, T., “Support Vector Machines Explained,” (Mar. 1, 2009), for a general explanation (which text is fully incorporated by reference herein).

Given a set of training examples in which each training example is marked as belonging to one or the other of two categories (i.e., true ECG signals versus noise and the like), a SVM training algorithm builds a model that assigns new examples to one category or the other, making it a non-probabilistic binary linear classifier. An SVM model is a representation of the examples as points in space, mapped so that the examples of the separate categories are divided by a clear gap that is as wide as possible. New examples are then mapped into that same space and predicted to belong to a category based on which side of the gap they fall.

As illustrated in FIG. 5, an initial universe of data can be taken from, for example, 11,000 ECG segments (sampled at, for example, 125 Hz) taken from an open source of ECG samples (like the online open-source database Kaggle, for example) on the one hand (see 302), and negative samples (e.g., the electrical noise signal taken from the sensors 102, 104 in interface device 100 without finger contact therewith) (see 304).

A training set 306 for training the SVM can therefore be, for example, 10,000 positive ECG samples and 1,000 negative samples, taken from the respective initial universe of data above. This forms the basis for the SVM to build a model at 308 to classify detected signals as a positive sample (i.e., a useful ECG signal) or a negative sample (i.e., noise).

In order to evaluate the predictive model built by the SVM at 308, a second set of data 312 for statistical cross-validation is taken from initial data sets 302, 304 (e.g., 1,000 of the positive samples and 915 of the negative samples) and used in the SVM model at step 310.

If the statistical C-statistic and goodness of fit (g) of the cross-validation classification results are sufficient at 314, then the SVM model is finally tested at 316 with an actual (“real life”) test set 318 of positive and negative samples (e.g., 10 ECG samples taken from the interface device 100, and 10 negative samples).

If the cross-validation is deemed not sufficiently accurate at 314 (“no”), the process returns to the SVM training step 308, using additional new training set data to reinforce the SVM model.

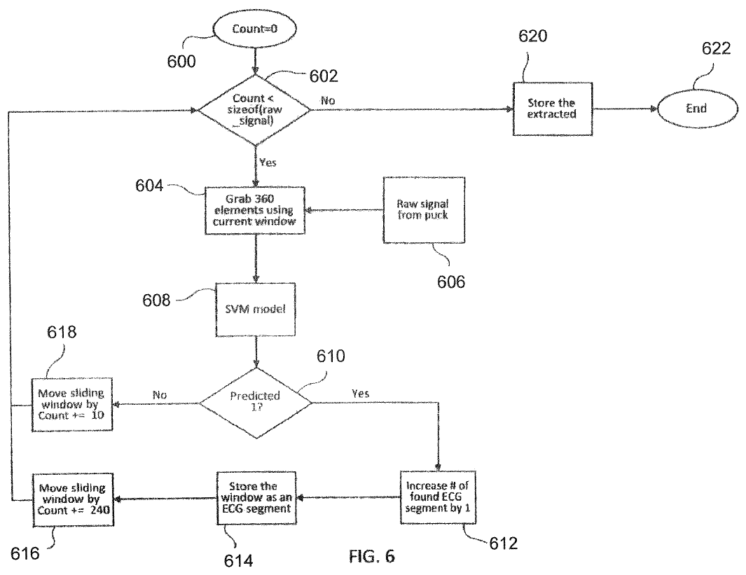

FIG. 6 illustrates a process of using the SVM for feature detection according to the present invention, and particularly in accordance with the SVM model built up according to FIG. 5.

In general, each raw input signal is considered as a plurality of sample segments of predetermined length as a function of time (usually a complete heartbeat cycle), usually determined as a function of sampling frequency, where each segment includes a certain number of elements (e.g., 100 elements).

The signal is indexed as a function of its overall size (i.e., length) and the process uses a sliding sample window or interval that “moves” along the signal, from which elements are taken from the signal for classification by the SVM model developed in FIG. 5.

Starting from a counter set at zero (600), the process checks to see if the counter is less than the overall size of the signal at 602 (i.e., the window is not at the end of the signal). At 604, a plurality of elements (e.g., 360 elements) are taken from the raw (but preprocessed) detected signal 606 (e.g., from the interface apparatus (“puck”) 100) from within the window. That plurality of elements is tested at 608 using the stored SVM model that has been established according to the explanation above. If an ECG segment is predicted at 610 (i.e., “yes”) the count of found ECG segments is increased by 1 at 612, and the window at that position is stored at 614 as an ECG segment. Then the window is indexed (i.e., moved forward) by a certain count (e.g., 240) at 616, and then the process returns to step 602.

If an ECG segment is not predicted at 610 (“no”), then the window is indexed forward at 618 by a smaller interval than that used if an ECG segment is predicted (here, for example, by 10), and the process again returns to step 602.

Once the window reaches the end of the signal (count≥size of raw signal in 602), the extracted ECG information is stored at 620. The extracted ECG information is a composite of the total number of segments captured. The process ends at 622.

Returning now to FIG. 3, it schematically illustrates a plurality 30 of ECG traces of interest (specifically, QRS intervals), relative to a plurality of random traces representing spurious noise, some of which are indicated at 32. The present invention contemplates a further level of probabilistic “clean up” in addition to the distinguishing operation of the SVM (sometimes referred to herein as “anomaly detection”). This is because the SVM model can still have “false positives” (i.e., signal segments identified as ECG segments by the SVM which are actually noise) because not all causes of noise can be technically accounted for.

Thus, anomaly detection in the present invention includes taking the stored ECG segments from 620 in FIG. 6 and fitting a Gaussian probability density function to a histogram of each element of an erstwhile extracted ECG segment from 620 (the histogram reflecting the number of elements within a given range of electrical potential). Recall here that an “element” as described herein is a subpart of a “segment.”

For example: if p(x)=Πᵢ₌₁¹⁰⁰p(xᵢ) is calculated, then if p(x)<∈ (i.e., when the probability that the segment is not a true ECG segment is not sufficiently high) where ∈ is an empirically calculated error term, than the segment is discarded as a noise anomaly.

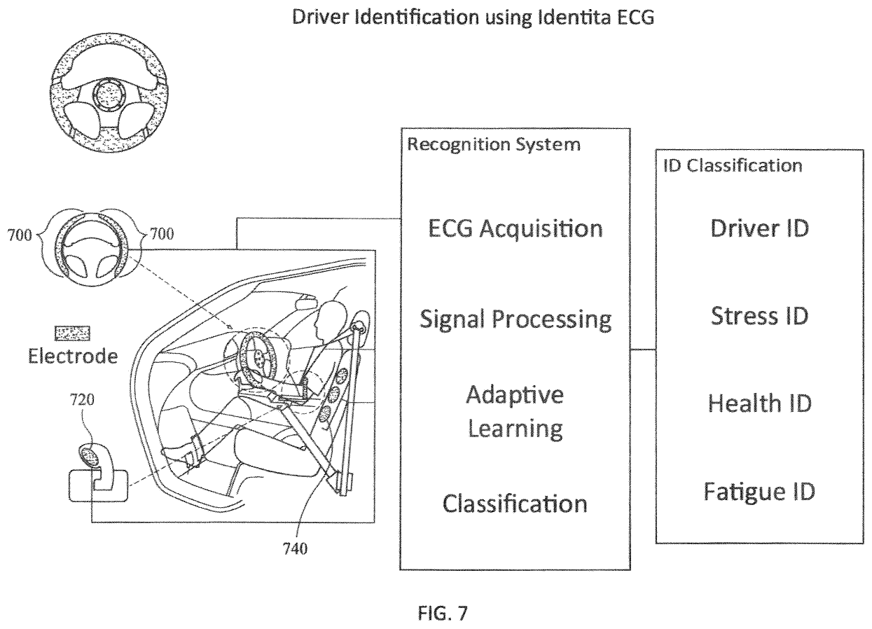

FIG. 7 schematically illustrates an example implementation of the present invention for use in identifying, for example, an authorized driver for a motor vehicle. For example, following system enrollment (for example, using the interface device 100 as discussed above) by an authorized driver, extracted data can be transferred by any operative mechanism to the motor vehicle for use in authorized driver authentication. For example, electrodes 700 for detecting ECG information could be placed along the circumference of the steering wheel, or an electrode 720 could be placed on a console-located gearshift. Electrodes 740 could even potentially be located in the seatback of the driver's seat.

In an extended application of the arrangement showing in FIG. 7, the driver ECG information detected according to the present invention could potentially be also used to assess one or more of driver stress levels, driver fatigue, or other aspects of driver health (e.g., consciousness/drowsiness).

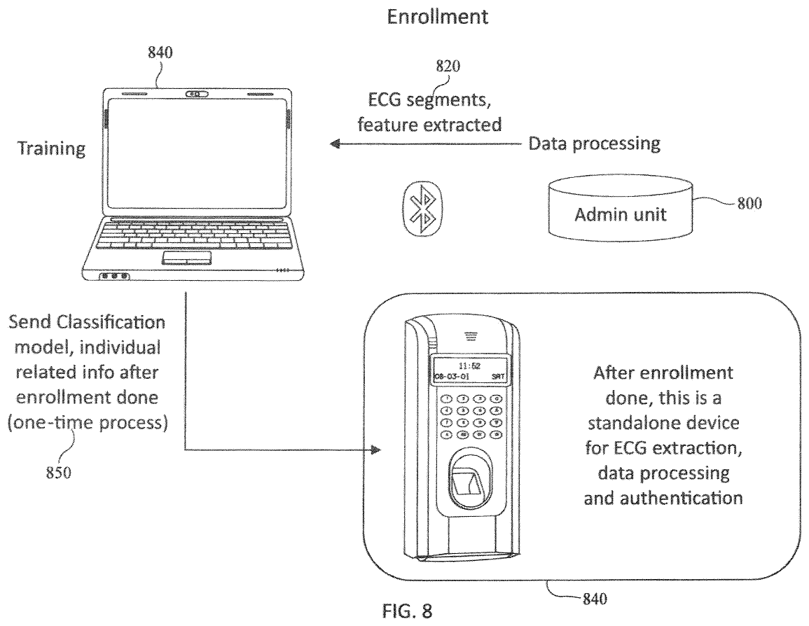

FIG. 8 illustrates a simple example of an implementation of the present invention between enrollment and use in authentication. For example, one or many users enroll (i.e., have their ECG information recorded for feature extraction as described above) via one or more suitable interface apparatuses 800 (essentially the device 100 described previously with reference to FIG. 4). The collected ECG information is processed as described above, and ECG segments and feature extraction information 820 is transmitted to a central computer device 840, e.g., via Bluetooth or other known, preferably secure, communication protocol for data transmission. The development, training, and validation of the desired classification model (e.g., a support vector machine or a suitable neural network) takes place at central computer device 840. Thereafter, the parameters of the trained classification model and accumulated enrollment information 850 is transmitted to a control terminal 860 suitably equipped to detect ECG information from a user (e.g., someone seeking to gain access to a secured entrance), process the detected ECG information, and authenticate the user using the relevant enrollment information. In a particular implementation, the terminal 860 is substantially standalone (e.g., in order to minimize avenues for illicitly accessing the terminal 860).

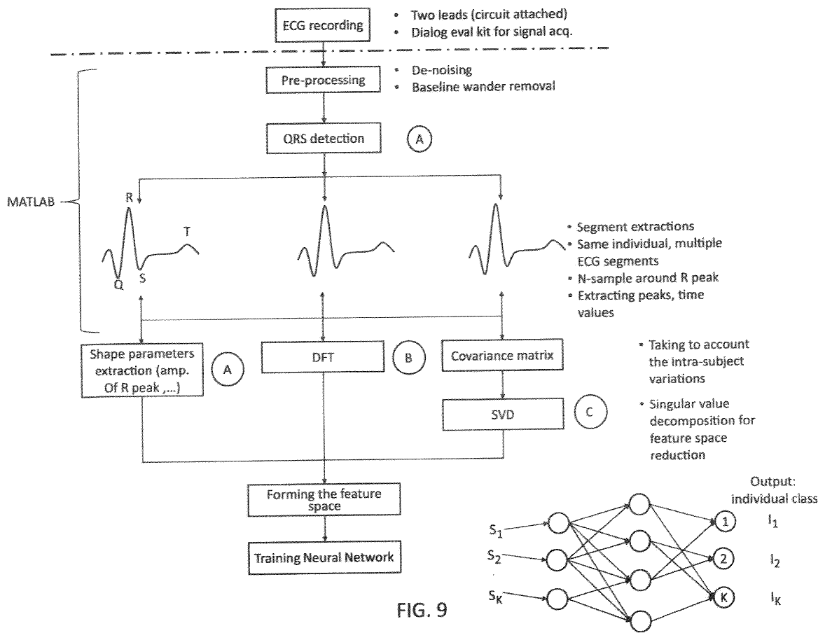

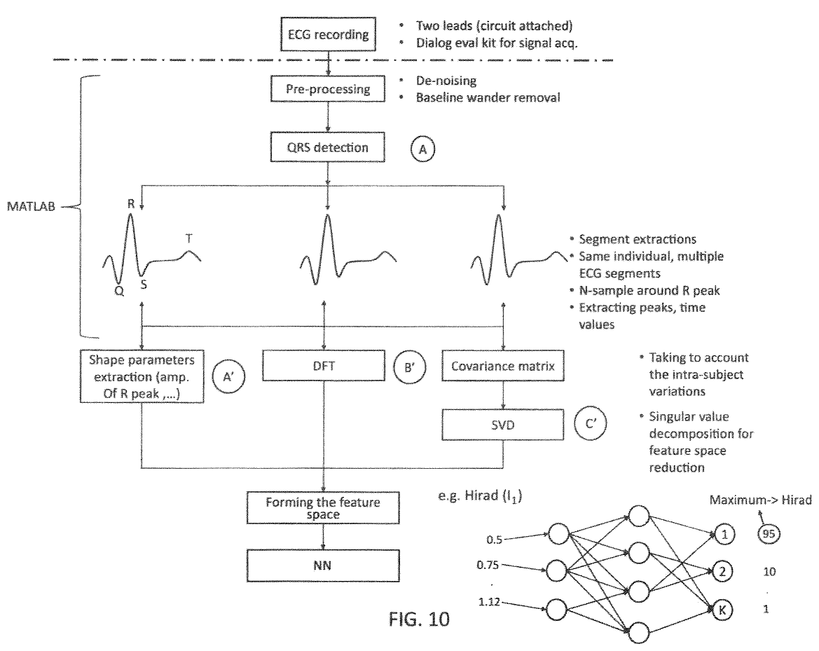

FIGS. 9 and 10 illustrate enrollment, training, and applied use of an ECG feature detection system using a neural network that is trained for feature classification.

For example, a deep neural network structure uses a multi-layered network in which each layer is responsible for extracting a particular set of features from a working input. For example, in the present invention, a first layer A (left side of FIG. 9) extracts time-based shape features (e.g., peak amplitudes), a second layer B (center path of FIG. 9) captures frequency contents of the QRS peak (including timing information in the feature space), while a third layer C (right path of FIG. 9) extracts a combination of features like P-Q distances or R-R distances between ECG segments for a single subject (this takes into account changes of ECG segments over a longer period of time (instead of the time duration of a single segment), or under different physiological states of a given subject.

As additional ECG data is accumulated from the detection/authentication process (FIG. 10) it can be added to the training dataset for the neural network. In one example, a covariance matrix can be calculated with new detected data, such as for every detection. If the least square error between singular values of the new covariance matrix and the prior matrix is higher than a predetermined threshold (empirically estimated from the ECG dataset), then retraining the neural network is carried out with the new data. If not, the new data is stored in order to round out the dataset used for training in a future iteration.

Generally, highly portable or even wearable implementations of the present invention are contemplated. This is advantageous to the extent that it permits identification and identity authentication functionality as described above to be carried out with greater case and with less dependence on static infrastructures. Thus, the present invention could, for example, be implemented in small, highly portable forms that are easily carried by a user, or that can be literally worn on the person—for example and without limitation, as a ring on a finger, a small device mounted on a strap on the user's arm (particularly on the wrist similar to a watch) or leg, or as pendant or the like suspended around the neck of the user.

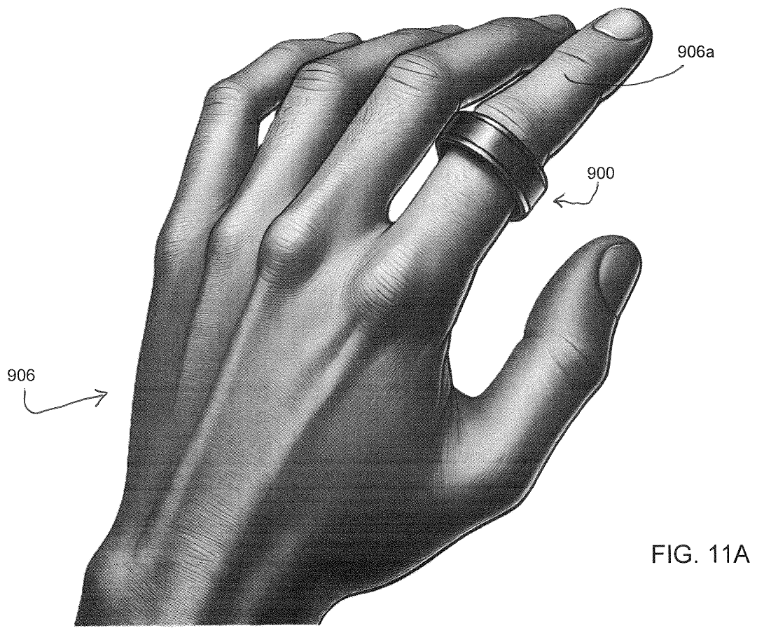

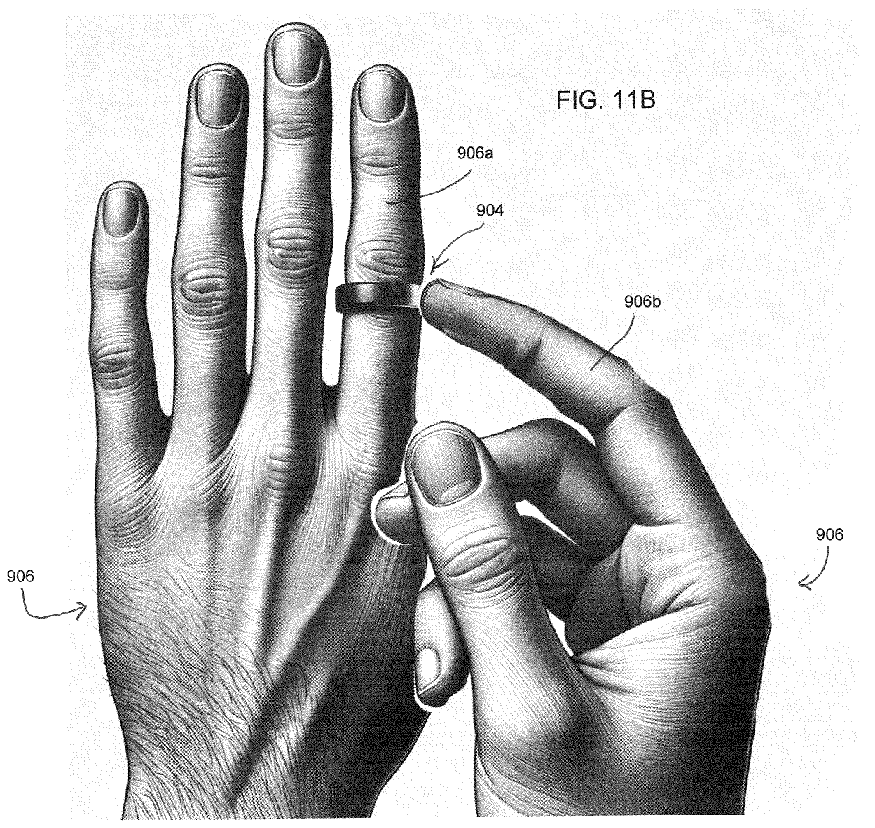

One example of such an implementation is a wearable ring device. FIGS. 11A and 11B illustrate a wearable ring device 900 on, for example, a finger 906a of a user's hand 906. (The placement of the ring device 900 on the index finger of the user is by way of illustration/example only, and use of the ring device 900 on any finger of the user's hand is contemplated.) The ring device 900 according to the present invention is advantageously even more compact and portable (for example, compared to the small interface device 100 of FIG. 4) and by its nature can be readily kept on a user's person. Also, the ring device 900 is not necessarily limited to placement on the fingers; placement on a toe, for example, is also contemplated, similar to the conventional use of ornamental toe rings and the like. However, strictly to simplify the disclosure here, a finger-worn ring device will be described hereinbelow as an example.

Generally, except for the ring form of device 900, the foregoing disclosure relative to interface device 100 is applicable here and incorporated by reference to the fullest extent possible, particularly but not only the description related to examples of signal preprocessing, enrollment, training, and use. In general, the ring device 900 provides functionality similar or identical to that described above relative to interface device 100.

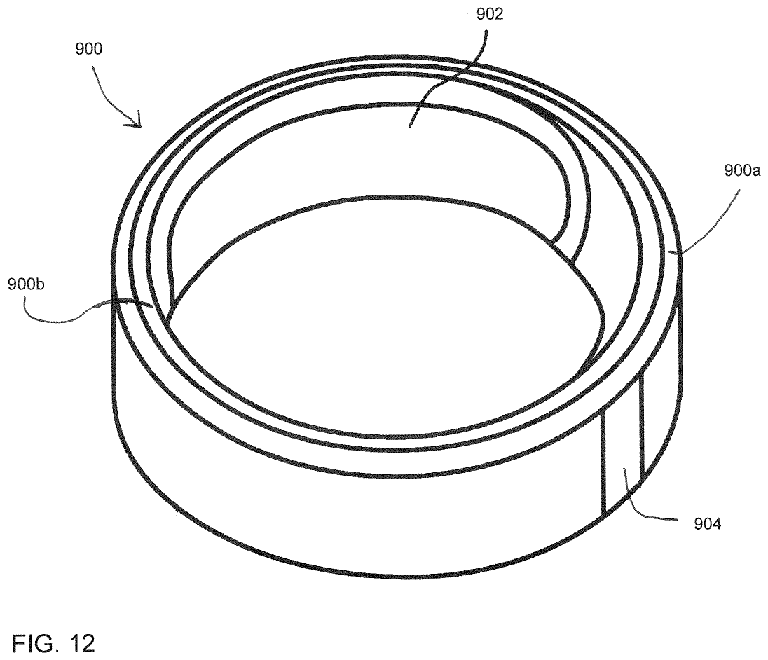

With reference to FIG. 12, in one example construction, ring device 900 comprises nested or otherwise interfitting outer and inner shells 900a, 900b which are preferably lockingly engaged (e.g., snap fit) or otherwise fixed to one another in a known manner after construction of the ring device 100 with the constituent electronics of the device housed therebetween.

The shells 900a, 900b may be made of any generally practicable material of construction (e.g., in terms of economics of manufacture as well as in view of technical considerations). For example, common hard and durable plastic manufacturing materials such as polycarbonates are attractive as a balance between cost, durability, and non-conductive characteristics, and are easily formed by, for example, molding. Metallic materials might cause a problem in terms of electrical conductivity and the possibility of picking up stray electro-muscular signals, but could be used if such issues are appropriately addressed according to known construction design approaches. In this regard, titanium could be used to construct the outer and/or inner shells 900a, 900b.

The exterior of the ring device 900 may, for example, be aesthetically gender-neutral (or alternatively, styled as separate men's and women's versions) and may be made in a variety of sizes to accommodate a variety of user sizes, such as, for example, a range of ring sizes as are conventionally known between 5 and 11 (i.e., inner diameters between about 15.6 mm and about 20.6 mm, for example and without limitation). Most generally, the axial length of the ring (i.e., perpendicular to said inner diameter) must assuredly accommodate the electronic components of the ring device 900 (discussed further below). For example and without limitation, the axial height of a ring device 900 for a finger could be between about ¼″ (about 6.4 mm) to about ½″ (about 12.7 mm).

Ring device 900 includes a radially inward facing main electrically conductive contact or sensor 902 for ECG signal detection that extends circumferentially at least part way about the inner surface of the ring device 900. As such, when the ring device 900 is worn by a user (e.g., on a finger 906a of the hand 906), the main sensor 902 is operably in constant contact with the underlying skin of the user and the ring device 900 can be effectively continuously ready for use according to the present invention. Similar to the disclosure above relative to interface device 100, the ring device 900 is operable and functional according to the present invention with the provision of only a single sensor like main sensor 902.

However, the ring device 900 can desirably also include a second, radially outwardly facing electrically conductive sensor 904 on an outer surface of the ring device 900. See, particularly, FIG. 12. This second sensor 904 can, for example, be selectively touched with a finger 906b of the opposite hand of the user (i.e., the hand opposite to the one on which the ring device 900 is worn; see, for example, FIG. 11B), in order to improve the quality of ECG signal detection through the use of multiple detection inputs as explained above. Optionally, the structure and/or appearance of the second sensor 904 may be made perceivably distinct (e.g., visually and/or tactilely) so as to facilitate localizing it for use according to the present invention. In a particular example of the invention, the second sensor 904 is smaller in extent than the main sensor 902. For example, the second sensor 904 may be, for example, about 10 mm by about 5 mm, whereas the main sensor 902 may extend, for example, about 4 mm to about 6 mm along the inward facing surface of ring device 900. In one example, the ring device 900 could be provided with an ornamental design or structure at a location on the radially outward surface of the ring device 900 intended to be kept visible (for aesthetic purposes) on the dorsal side of the finger, but with the net effect of optimally positioning main sensor 902 and second sensor 904.

In addition, the second sensor 904 may be made from an electrically capacitive material (or equivalent functionally-suitable material) so as to additionally function as a fingerprint scanner or detector, in accordance with the comparable disclosure relative to interface device 100 above. This provides “backup” identification and/or authentication functionality to the core ECG-based functionality of the present invention.

The second sensor 904, if configured to detect a user's fingerprint as disclosed here, can also be used as a kind of two-factor authentication (i.e., in addition to ECG-based authentication according to the present invention), conceptually analogous to receiving (and subsequently inputting) an out-of-channel security or confirmation code in order to complete an online transaction. In other circumstances, it could be used as a kind of “confirm to proceed” action, using an input fingerprint to authorize a sensitive action (e.g., authorizing mass deletion of data or finalizing an online purchase).

The main sensor 902 can potentially also be constructed in accordance with the foregoing to be able to detect a fingerprint. But because of the disposition of the main sensor 902 in opposition to the finger of the wearer, it is expected that only the second sensor 904 will usually be so configured (e.g., to avoid additional steps in use, such as having to remove the ring device 900 from the finger in order to use main sensor 902 to detect a fingerprint).

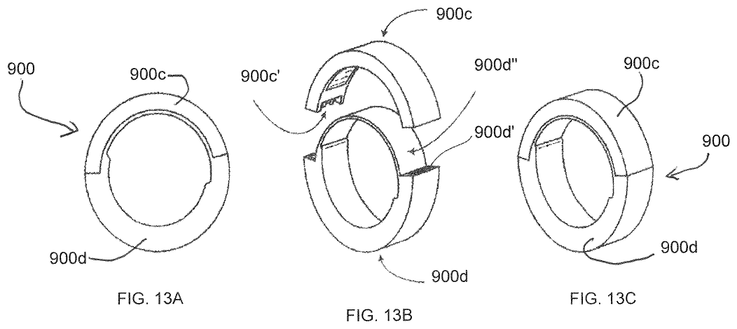

FIGS. 13A-13C schematically illustrate a different example construction of ring device 900 compared to that illustrated in FIG. 12, in which the device comprises parts (for example, semicircular portions) that are assembled together generally along a direction parallel to the diameter of the ring device 900—that is, generally “laterally” as opposed to concentrically as in FIG. 12. See, especially, FIG. 13B. It should be noted here that the dimensional relationships visually represented in FIGS. 13A-13C may be exaggerated in order to facilitate visualization and are not necessarily proportional.

Here, then, the ring device 900 generally comprises lateral portions 900c and 900d, respectively, in contrast to the concentric outer shell 900a and inner shell 900b in FIG. 12. Generally speaking, each lateral portion 900c and 900d is a curved compartment (i.e., having a space defined between radially inner and outer walls and radially extending side walls for housing the necessary electronic elements of the ring device 900. Electrical connectivity between 900c and 900d could be provided by respective electrical connections at the ends of portions 900c (see, for example, 900c′) and 900d (see, for example, 900d′) which engage in a socket-plug like engagement when the respective portions are assembled. Alternatively (or additionally), portions 900c, 900d could electrically communicate with one another via, for example, a conductive band (or similarly shaped circuit board or the like) 900d″ (see FIG. 13B) extending in arcuate fashion between the opposing ends of portion 900d (generally conforming to the interior circumference of the ring device 900). The curved band 900d″ could be generally electrically conductive, or may have specific wiring and/or electrical contacts formed thereon that electrically communicate with corresponding electrical wiring or electrical contacts on the radially inward surface of portion 900c.

In any event, the portions 900c and 900d are fixedly engaged with one another via known assembly methods (see FIG. 13C) to collectively form the ring device 900 as seen in plan in FIG. 13A and in perspective view in FIG. 13C.

As a general matter, the features and functionality disclosed above relative to the block diagram in FIG. 4A are presumptively applicable to the ring device 900, subject to any size constraints imposed by the physical form of the ring device 900 (or, more generally, the smaller form of a portable or wearable implementation of the present invention), in which case functionally equivalent and appropriately sized known equivalents can be substituted.

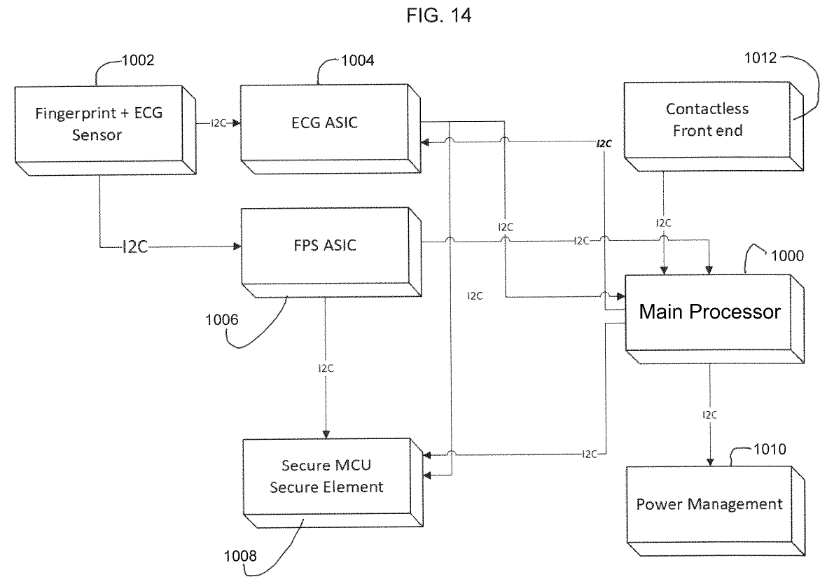

FIG. 14 is another block diagram corresponding to an example internal architecture of the ring device 900. As with FIG. 4A, the disclosed arrangements discussed with reference to specific clements is by way of illustrative example only, other working arrangements of elements are foreseeably possible in accordance with the overall description of the present invention herein.

In general, required processing power in ring device 900 is principally provided at main processor 1000, via, for example, the nRF54L15 system-on-chip from Nordic Semiconductor, which includes (desirably in combination) an ARM processor, on-board volatile and/or non-volatile memory (conceptually generally corresponding to the NAND or FRAM flash memory element 408 in FIG. 4A), and on-board Bluetooth communication functionality (conceptually corresponding to BLE module 406 in FIG. 4A).

ECG sensor functionality (and, optionally, fingerprint detection functionality) is generally represented at 1002 (corresponding to, for example, sensors 902, 904 in FIG. 12). ECG sensor functionality could be provided by commercially available sensors (for example, as is/was commercially available from Plessey Semiconductors, Ltd. in the United Kingdom, Part No. PS252555). As mentioned, the second sensor 904 could be configured as a combination ECG sensor and fingerprint detector/scanner by using an electrically capacitive material as is known in the art. Alternatively, if only fingerprint detection functionality is desired in second sensor 904, the IDX3200 fingerprint sensor assembly from IDEX ASA of Norway is commercially available and can be used in this role.

Block 1002 communicates (e.g., via an inter-integrated circuit (I2C) serial communication protocol) with an ECG ASIC 1004 (and/or, as appropriate, a fingerprint sensor (FPS) ASIC 1006). Here again, the ECG ASIC 1004 could be the commercially available NeuroSky BMD101 CardioChip biosensor providing digital signal processing functionality. The FPS ASIC 1006 could be, for example, the IDEX 3200/3400 commercially available from IDEX ASA.

Block 1008 is a secure element microprocessor, such as the SLC39B system-on-chip cryptoprocessor commercially available from Infineon. The secure clement 1008 can, for example, communicate with the ECG ASIC 1004, the FPS ASIC 1006, as well as main processor 1000—all via, for example, I2C communication protocols. The secure element microprocessor 1008 operates to protect sensitive information involved in the present invention (e.g., via encryption), such as the biometric input and reference templates corresponding to the ECG and fingerprint information collected via sensors 902, 904.

The ring device 900 may be configured to use a known commonly used operating system, as needed, such as, for example and without limitation, JCOP (Java Card), VxWorks, Zephyr, or Android OS.

The ring device 900 may communicate with external devices/networks and the like via Bluetooth (for example, provided by the nRF54L15 system-on-chip) and/or via other conventionally-known wireless/contactless communication protocols such as RFID generally or near-field communication (NFC) particularly, provided via a contactless front end (block 1012).

Lastly, the ring device 900 is generally powered by an appropriately sized on-board battery, preferably rechargeable and with a capacity of, for example, about 50 to about 250 mAh. The battery (part of power management block 1010) may be recharged in any conventional manner, including, for example and without limitation, via charger cable or wireless charging pads and the like using inductive charging. In a particular example of the present invention, an outward facing portion of the ring device 900 (particularly, but not necessarily only, a radially outward facing surface of the ring device 900) can be provided with a photovoltaic material to recharge an onboard rechargeable battery. The photovoltaic material would be integrated via a power management unit such as the AEM10900 or AEM13920 charging circuits commercially available from e-Peas S.A. of Belgium. Alternatively, the ring device 900 could also be recharged using transient RF energy and a properly tuned antenna such that any proximal wireless network energy (e.g., BLE, Wi-Fi, NFC or cellular networks) could be used in combination with a power management unit such as the PCC114 from Powercast Corporation.

Although the use of I2C communication protocols is illustrated in FIG. 14 by way of working example, other known, application-appropriate communication protocols could be used.

Although the present invention is described above with reference to certain particular examples for the purpose of illustrating and explaining the invention, it must be understood that the invention is not limited solely with reference to the specific details of those examples. More particularly, the person skilled in the art will readily understand that modifications and developments that can be carried out in the preferred embodiments without thereby going beyond the ambit of the invention as defined in the accompanying claims.

What is claimed is:

1. A wearable biometric authentication device for authenticating an individual claiming to be a known user and configured to be worn in operable contact with the individual's body, the device comprising:
at least one sensor sized, constructed, and arranged for receiving input ECG signals from the individual claiming to be the known user;
a processor operably connected to the at least one sensor and constructed and arranged for processing the received input ECG signals; and
a memory operably connected with the processor and including processor instructions for:
converting the received input ECG signals into an input biometric template;
comparing the input biometric template to a previously stored reference biometric template corresponding to previously received ECG signals from the known user; and
authenticating the individual as the known user based on the comparison of the input biometric template and the reference biometric template;
the memory further including processor instructions for machine-learning based signal processing of one or both of the previously received ECG signals from the known user and the received input ECG signals from the individual being authenticated to distinguish true ECG signal elements from signal noise.

2. The device according to claim 1, further comprising a biosensor operably between the at least one sensor and the processor and constructed and arranged for pre-processing the received input ECG signals.

3. The device according claim 1, wherein the machine-learning based signal processing is one of:
using a support-vector machine (SVM) previously trained using a first plurality of generic ECG signals and a first plurality of noise signals to generate a classification model for distinguishing true ECG signal elements from signal noise; and
using a trained neural network for ECG feature classification.

4. The device according to claim 1, wherein:
the at least one sensor is also sized, constructed, and arranged for receiving ECG signals from the known user; and
the memory additionally includes processor instructions for: converting the ECG signals from the known user into the reference biometric template; and for machine-learning based signal processing of the ECG signals from the known user to distinguish true ECG signal elements from signal noise.

5. The device according to claim 4, wherein the memory is constructed and arranged to store the reference biometric template onboard the device.

6. The device according to claim 1, further comprising a power source constructed and arranged to supply power to the device.

7. The device according to claim 1, wherein the at least one sensor is a capacitive touch sensor constructed and arranged to additionally function as a fingerprint scanner.

8. The device according to claim 1, wherein the device is a single structural unit comprising therein the assembly of the at least one sensor, the processor, and the memory.

9. The device according to claim 8, wherein the device is a ring worn on a digit of the individual's body.

10. The device according to claim 8, wherein the device is constructed and arranged to be one of:
suspended around the neck of the individual so as to generally rest against or in proximity to the individual's body;
mounted on an arm of the individual; and
mounted on a leg of the individual.

11. The device according to claim 3, wherein the training of the SVM comprises refining the classification model generated by the SVM using a statistical cross-validation data set comprising a second plurality of generic ECG signals and a second plurality of noise signals, wherein the second pluralities of generic ECG and noise signals are different from the first pluralities of generic ECG and noise signals.

12. The device according to claim 11, wherein the cross-validation is repeated with new second pluralities of generic ECG signals and noise signals until the classification model achieves a desired level of statistical accuracy.

13. The device according to claim 12, wherein the desired level of statistical accuracy is considered in terms of a C-statistic and a goodness of fit.

14. The device according to claim 3, wherein the processor instructions include instructions for obtaining the previously received ECG signals from the known user in increments by:
subjecting an interval of an input signal within a window to classification by the SVM, wherein the window has a predetermined length and the input signal has an overall length;
wherein if the input signal interval is classified as an ECG signal segment by the SVM then the input signal interval is stored as an ECG signal segment and the window is displaced by a first displacement along the length of the input signal, and if the input signal interval is identified as not being an ECG signal segment then the window is displaced by a second displacement along the length along the length of the input signal, wherein the second displacement is smaller than the first displacement;
wherein the new input signal interval defined by the displaced window is subjected to SVM classification and the window is again displaced by a distance depending on whether or not the input signal interval is identified as an ECG signal segment, the displacement of the window being repeated until the window reaches or exceeds the end of the input signal.

15. The device according to claim 14, wherein each stored ECG signal segment is divided into a plurality of elements which are arranged in a histogram based on whether each segment falls into a given interval of electrical potentials and a Gaussian probability distribution function is fit to the histogram;
wherein subsequent ECG signal segments obtained from the SVM classification are compared to the Gaussian probability distribution function to gauge the probability that a given subsequent ECG signal segment is indeed an ECG signal segment.

16. The device according to claim 9, wherein the at least one sensor is disposed on a radially inward facing surface of the ring such that the at least one sensor is in contact with the digit of the individual's body upon which the ring is worn.

17. The device according to claim 9, wherein the ring is worn on a finger of the individual's hand and comprises a first sensor for receiving input ECG signals disposed on a radially inward facing surface of the ring in a location contacting the finger upon which the ring is worn, and a second sensor operably connected to the processor and constructed and arranged for receiving input ECG signals and disposed on a radially outward facing surface of the ring, the second sensor being sized to be selectively contacted by another finger of the individual other than the finger upon which the the ring is worn.

18. The device according to claim 17, wherein the second sensor is additionally operable as a fingerprint scanner constructed and arranged to scan the finger print of the another finger of the individual.

19. The device according to claim 17, wherein the first sensor extends circumferentially along the radially inward facing surface of the ring, and the second sensor extends circumferentially along the radially outward facing surface of the ring to a shorter circumferential extent than the first sensor.

20. (canceled)

21. (canceled)

22. (canceled)

23. (canceled)

24. (canceled)

25. (canceled)

26. (canceled)
